(19) United States
(12) Patent Application Publication
(10) Pub. No.: US 2010/0002788 A1
(43) Pub. Date: Jan. 7, 2010

(54) INTERPOLATING METHOD FOR AN OFDM SYSTEM AND CHANNEL ESTIMATION METHOD AND APPARATUS

(76) Inventors: Yiling Wu, Beijing (CN); Li Zou, Beijing (CN); Peng Liu, Beijing (CN)

Correspondence Address: Robert D. Shedd, Patent Operations;THOMSON Licensing LLC, P.O. Box 5312, Princeton, NJ, 08543-5312, US

(21) Appl. No.: 12/448,886

(22) PCT Filed: Jan. 19, 2007
(86) PCT No.: PCT/CN2007/000208

§ 371 Date: Jul. 13, 2009

(51) Int. Cl. H04L 27/28

(52) U.S. Cl. 375/260

(57) ABSTRACT

The present invention provides an interpolating method for an OFDM system, a channel estimation method and apparatus, in which each OFDM symbol has scattered pilots inserted, and the interpolating method comprising: the step of inserting at least one copy of the first scattered pilot in each OFDM symbol before the first scattered pilot as virtual pilots, and inserting at least one copy of the last scattered pilot in each OFDM symbol behind the last scattered pilot as virtual pilots, after obtaining the channel state information on the sub-channels which propagate the scattered pilots in the OFDM symbols by linear filtering; and the step of performing interpolation by a FIR filter with the channel state information.

### FIELD OF THE INVENTION

The present invention relates generally to communication technologies, and particularly to an interpolating method for an OFDM system, a channel estimation method and apparatus.

### BACKGROUND OF THE INVENTION

OFDM technology is one of the key solutions for multi-path channel condition in wireless wideband communication. In many pilot-aided OFDM-based systems, channel estimation uses frequency-domain filtering technology such as wiener filter to beat multi-path channel condition (“Two-dimensional pilot-symbol-aided channel estimation by Wiener filtering”). In order to calculate the channel coefficients exactly, FIR filter is generally used to implement channel estimation apparatus. A frequency-domain interpolator apparatus usually treats the OFDM symbols to three parts: the beginning part, the body part, and the end part. The interpolating methods applied to these parts are different. However, such especial treatment leads high cost in the hardware design because much memory resource is needed to store these coefficients which are used only once in many cycles. Besides, the contents of registers caching filter coefficients should be refreshed frequently, which results in complex control logic and consumes more power.

### SUMMARY OF THE INVENTION

To solve one of problems above-mentioned, an interpolating method for an OFDM system, a channel estimation method and apparatus are provided in accordance with the present invention.

In accordance with the present invention, the interpolating method for an OFDM system, in which each OFDM symbol has scattered pilots inserted therein, comprises: S602, inserting at least one copy of the first scattered pilot in each OFDM symbol before the first scattered pilot as virtual pilots, and inserting at least one copy of the last scattered pilot in each OFDM symbol behind the last scattered pilot as virtual pilots, after obtaining the channel state information (CSI) on the sub-channels which propagate the scattered pilots in the OFDM symbols by linear filtering; and S604, performing interpolation by a FIR filter with the channel state information.

In accordance with the present invention, the channel estimation method for an OFDM system comprises: S702, estimating the CSI of received scattered pilots in OFDM symbols by dividing the known transmitted scattered pilots; S704, performing linear filtering to the OFDM symbols to obtain the channel state information on the sub-channel which propagate the scattered pilots and storing the channel state information; and S706, inserting at least one copy of the first scattered pilot in each OFDM symbol before the first scattered pilot as virtual pilots and inserting at least one copy of the last scattered pilot in each OFDM symbol behind the last scattered pilot as virtual pilots, and performing channel estimation by interpolating with a FIR filter using the channel state information.

In accordance with the present invention, the channel estimation apparatus comprises: a pre-processor for performing channel estimation of the scattered pilots in OFDM symbols; a time domain interpolation module, coupled to the pre-processor, for performing linear filtering to the OFDM symbols to obtain the channel state information on the sub-channels which propagate the scattered pilots; and a frequency domain interpolation module, coupled to the time domain interpolation module, for inserting at least one copy of the first scattered pilot in each OFDM symbol before the first scattered pilot as virtual pilots, and inserting at least one copy of the last scattered pilot in each OFDM symbol behind the last scattered pilot as virtual pilots, and performing channel estimation by interpolating with a FIR filter using the channel state information.

In accordance with the present invention, the interpolation can be performed according to the following formula:

$$csi\_f \_int p ( m , n ) = {\sum }_{i = 1}^{fil\_len} csi\_t \_int p ( m , n - \frac{3}{2} \cdot fil\_len + 3 gi - 2 ) \cdot fil\_co ( i )$$

Other objects, advantages, and novel features of the present invention will become more apparent from the following detailed description when taken in conjunction with the accompanying drawings.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention together with the description which serves to explain the principle of the invention. In the drawings:

FIG. 1 shows the pattern of scattered pilots;

FIG. 2 shows the pattern of sub-carriers which CSI is known;

FIG. 3 shows the conventional frequency domain interpolation of the middle part;

FIG. 4 shows the conventional frequency domain interpolation of the beginning part;

FIG. 5 shows the conventional frequency domain interpolation of the ending part;

FIG. 6 shows the flowchart of the interpolating method for an OFDM system in accordance with the embodiment of the present invention;

FIG. 7 shows the flowchart of the channel estimation method in accordance with the embodiment of the present invention;

FIG. 8 shows the channel estimation apparatus in accordance with the embodiment of the present invention;

FIG. 9 shows the modified frequency domain interpolation of the beginning part in accordance with the embodiment of the present invention; and

FIG. 10 shows the modified frequency domain interpolation of the ending part in accordance with the embodiment of the present invention.

### DETAILED DESCRIPTION OF THE PREFERRED EMBODIMENT

The technical features of the present invention will be described further with reference to the embodiments. The embodiments are only preferable examples without being limited to the present invention. It will be well understood by the skilled person in the art upon reading the following detailed description in conjunction with the accompanying drawings.

In pilot-aided OFDM systems, process of channel estimation is usually preformed by scattered pilot information contained in the OFDM signal. Scattered pilots provide a reference signal of known amplitude and phase on every n OFDM sub-carriers per OFDM symbol. Channel estimation can be achieved by interpolating in both time domain and frequency domain. Usually, filtering is used to be as the frequency domain interpolation method.

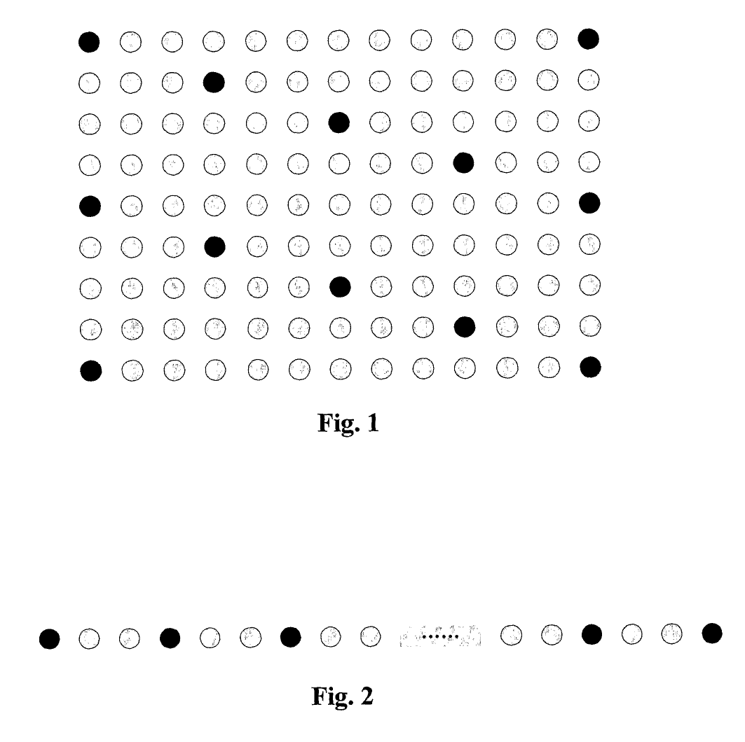

The frequency domain interpolation in DVB-T systems and a 12-tap wiener filter might be taken as examples. The pattern of scattered pilots in DVB-T systems can be referred in FIG. 1. Here, black points represent scattered pilots while white points represent received data, TPS and continual pilots.

FIG. 2 shows the pattern of the sub-carriers whose CSI are known after time domain interpolation. Those sub-carriers are either scattered pilot sub-carriers or the ones interpolated in time domain.

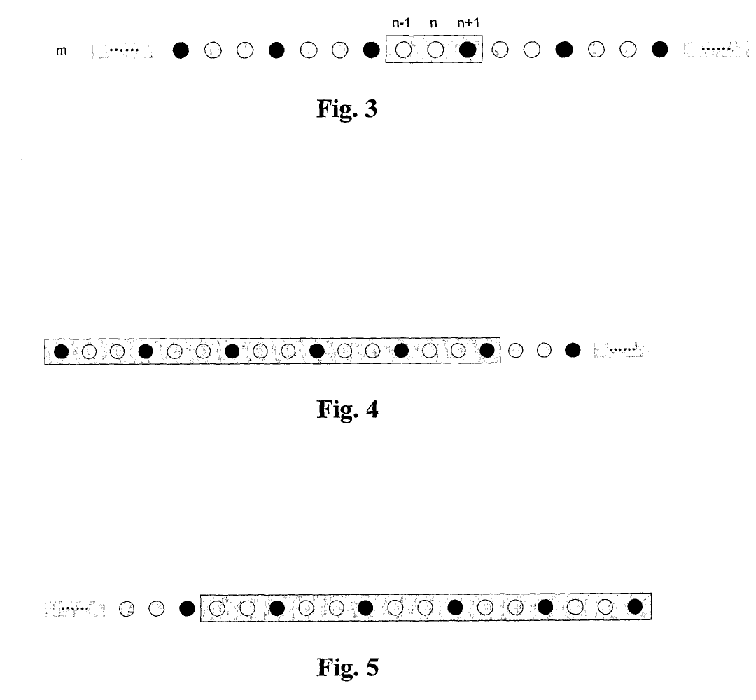

For the white point in the middle part of an OFDM symbol, the 12-tap wiener filter uses the six black points before it and six black points behind it to do interpolation. For the black point in the middle part, the wiener filter uses the six black points before it, five black points behind it, and itself to do interpolation. As shown in FIG. 3, two white points and a black one can be grouped together to form one epoch of frequency domain interpolation. Formulas (6)-(8) show the way of calculating CSI of these sub-carriers.

$$\begin{matrix}csi\_f \_int p ( m , n - 1 ) = {\sum }_{i = 1}^{fil\_len} csi\_t \_int p ( m , ( n - 1 ) - \frac{3}{2} \cdot fil\_len + 3 gi - 1 ) \cdot fil\_co ( i ) & ( 6 ) \\ csi\_f \_int p ( m , n ) = {\sum }_{i = 1}^{fil\_len} csi\_t \_int p ( m , n - \frac{3}{2} \cdot fil\_len + 3 gi - 2 ) \cdot fil\_co ( i ) & ( 7 ) \\ csi\_f \_int p ( m , n + 1 ) = {\sum }_{i = 1}^{fil\_len} csi\_t \_int p ( m , ( n + 1 ) - \frac{3}{2} \cdot fil\_len + 3 gi - 1 ) \cdot fil\_co ( i ) & ( 8 )\end{matrix}$$

However, the beginning part and ending part of an OFDM symbol should be specially treated. In the beginning part, there aren't enough black points before them to do wiener filtering. So, the first twelve black points are used for the interpolation of all the first sixteen points. And the coefficients for each point should be calculated separately. This is also the case for the points in the ending part. The last fifteen points should be treated differently from the ones in the middle part.

Therefore, thirty-four groups of wiener filter coefficient should be calculated and stored for frequency domain interpolation. Besides, some control logic should be added to refresh the coefficients when processing the head and the tail of an OFDM symbol. These result in a low efficient design because only three groups of coefficients are used frequently and the control logic also works during only a few clock cycles.

To the best of our knowledge, frequency-domain interpolating method usually treated the beginning part and the ending part of an OFDM symbol particularly. In order to save more memory and more power consumption, the present invention suggested inserting dummy pilots before being processed, and then the particular processing for the beginning and ending part for each OFDM symbols is removed. By adding the copies the first pilot sub-carrier and the last one to the head and the tail of an OFDM symbol as virtual pilots, the sub-carriers in beginning part and ending part can be processed as those in the middle part. Therefore, the number of groups of filter coefficients can be significantly reduced, which results in much less memory resource, simpler control logic, and less power consumption.

To solve the problem, an interpolating method for an OFDM system is provided. As shown in FIG. 6, the interpolating method for an OFDM system, in which each OFDM symbol has scattered pilots inserted therein, comprising the steps of S602, inserting at least one copy of the first scattered pilot in each OFDM symbol before the first scattered pilot as virtual pilots, and inserting at least one copy of the last scattered pilot in each OFDM symbol behind the last scattered pilot as virtual pilots, after obtaining the channel state information on the sub-channels which propagate the scattered pilots in the OFDM symbols by linear filtering; and S604, performing interpolation by a FIR filter with the channel state information.

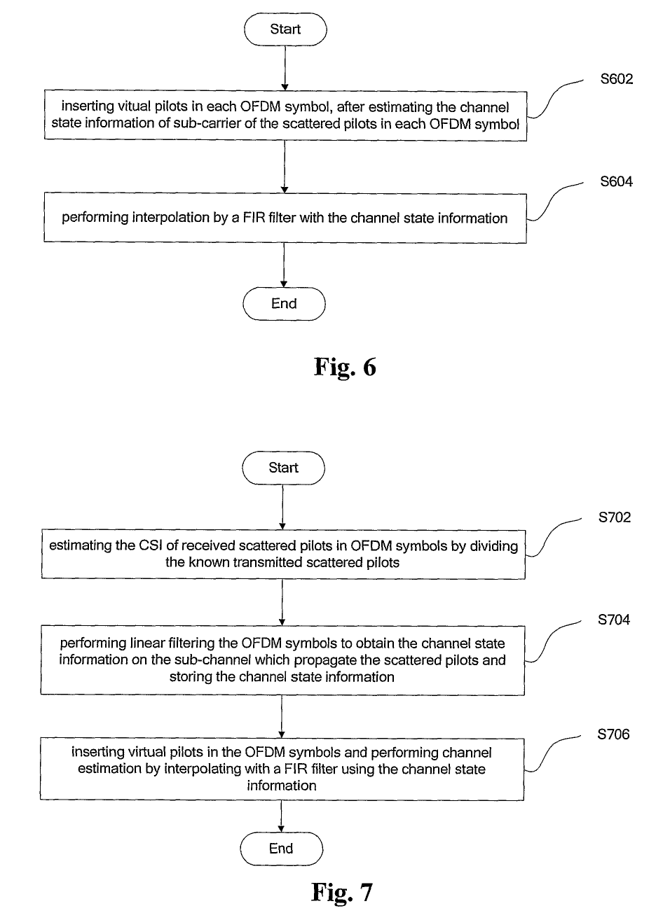

As shown in FIG. 7, a channel estimation method for an OFDM system is provided, which starts from step S702, estimating CSI of received scattered pilots in OFDM symbols by dividing the known transmitted scattered pilots; S704, performing linear filtering to the OFDM symbols to obtain the channel state information on the sub-channel which propagate the scattered pilots and storing the channel state information; and S706, inserting at least one copy of the first scattered pilot in each OFDM symbol before the first scattered pilot as virtual pilots and inserting at least one copy of the last scattered pilot in each OFDM symbol behind the last scattered pilot as virtual pilots, and performing channel estimation by interpolating with a FIR filter using the channel state information.

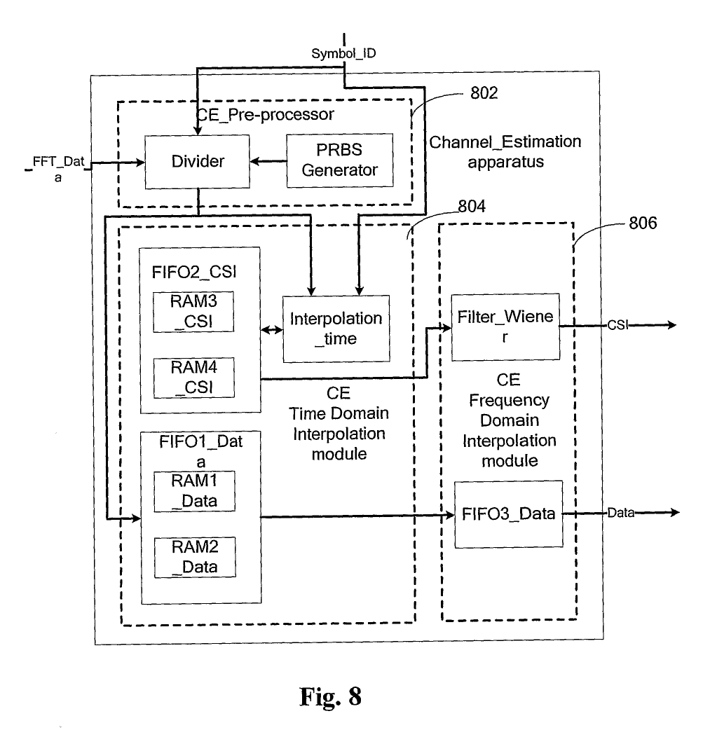

Referring to FIG. 8, it shows the channel estimation apparatus in accordance with the present invention. The frequency domain channel estimation apparatus comprises a pre-processor 802, a time domain interpolation module 804, and a frequency domain interpolation module 806.

The pre-processor 802 is configured to perform channel estimation of the scattered pilots in OFDM symbols.

The time domain interpolation module 804 is coupled to the pre-processor and configured to perform linear filtering to the OFDM symbols to obtain the channel state information on the sub-channels which propagate the scattered pilots. In the time domain interpolation module, RAMs are used as FIFO to cache the received data and the calculated CSI. The linear filtering can be simply implemented by using shifters and adders.

The frequency domain interpolation module 806 is coupled to the time domain interpolation module and configured to insert at least one copy of the first scattered pilot in each OFDM symbol before the first scattered pilot as virtual pilots, and insert at least one copy of the last scattered pilot in each OFDM symbol behind the last scattered pilot as virtual pilots, and performing channel estimation by interpolating with a FIR filter using the channel state information.

The main unit of the frequency domain interpolation module is a wiener filter. Besides, it needs a ROM to store the coefficients of wiener filter and a group of registers to cache the coefficients.

In the above-mentioned methods and apparatus, the interpolation can be performed according to the following formula:

$$csi\_f \_int p ( m , n ) = {\sum }_{i = 1}^{fil\_len} csi\_t \_int p ( m , n - \frac{3}{2} \cdot fil\_len + 3 gi - 2 ) \cdot fil\_co ( i ) .$$

The interval between the inserted scattered pilots satisfies Nyquist sampling theorem. The number of the virtual pilots is determined to be half length of the FIR filter.

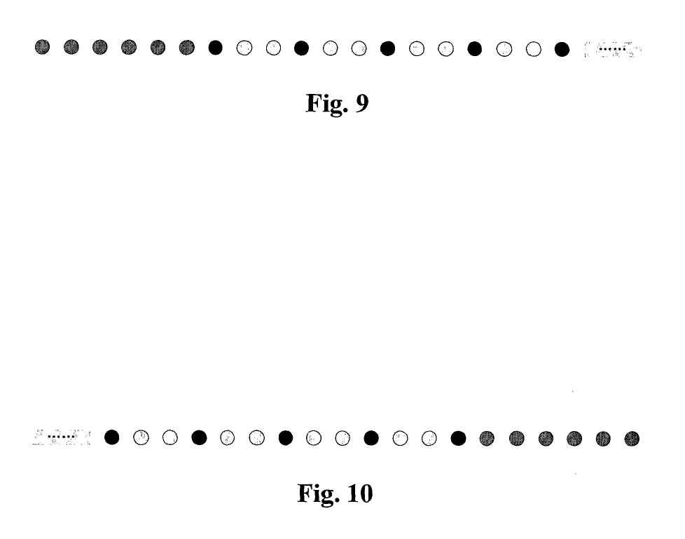

As shown in FIGS. 9 and 10, some gray points are added to the left side of the beginning part and right side of the ending part. These gray points represent the copies of the first black point (FIG. 4) and the last black point (FIG. 5). Then all the points can be interpolated in the same way as the point in the middle part does. For example, the first white point can use the second to the sixth gray points, the black point before it and six black points behind it to do filtering.

By adding some virtual pilots, only 3 groups of coefficient need to be stored. Besides, the control logic is also simplified significantly since the refreshment of coefficient becomes cyclical.

The BER (Bit Error Rate) performance is simulated in DVB-T system. From Table 1 as below, it can be seen that the “virtual pilot” method proposed by the present invention works as well as traditional filter.

TABLE 1
Comparison between three methods

| | BER | Hardware resource cost |
|---|---|---|
| Traditional filter | 1.2545e−004 | 4896 bits RAM |
| (wiener) | | Complex control logic |
| Filter with virtual | 1.4295e−004 | 432 bits RAM |
| pilot (wiener) | | Simple control logic |

The BER performance simulation is done in DVB-T system. The simulation parameters are listed in Table 2. To know performance of frequency-domain interpolation accurately, only the module of frequency-domain interpolation uses fixed-point simulation but other modules use float-point simulation.

TABLE 2
Parameter settings in BER performance simulation

| | |
|---|---|
| Code rate | 2/3 |
| Modulation | 16QAM |
| SNR | 12.2 dB |
| Channel | Rayleigh (ETSI) |
| FFT length | 2K |
| Wordlength | 12 bits |

Using the method proposed by the present invention, the beginning part and the ending part of an OFDM symbol need no longer to be treated particularly if filtering is used for interpolating. Then, much less memory resource is needed to store the filter coefficients and the control logic is also significantly simplified. Consequently, more memory and more power are saved.

The specific applications could be channel estimation module in the receiver of pilot-based multi-carrier system, such as DVB-T demodulator IP core, DVB-T demodulator chip, DVB-H demodulator IP core, DVB-H demodulator chip, 802.16a demodulator IP core, 802.16 demodulator chip, etc. The complexity of receiver to handle multi-path channels will be greatly reduced.

Whilst there has been described in the forgoing description preferred embodiments and aspects of the present invention, it will be understood by those skilled in the art that many variations in details of design or construction may be made without departing from the present invention. The present invention extends to all features disclosed both individually, and in all possible permutations and combinations.

1-12. (canceled)

13. An interpolating method for an OFDM system in which each OFDM symbol has scattered pilots inserted therein, comprising:
inserting at least one copy of the first scattered pilot in each OFDM symbol before the first scattered pilot as virtual pilots, and inserting at least one copy of the last scattered pilot in each OFDM symbol behind the last scattered pilot as virtual pilots, after obtaining the channel state information on the sub-channels which propagate the scattered pilots in the OFDM symbols; and
performing interpolation by a FIR filter with the channel state information.

14. The interpolating method according to claim 13, wherein the channel state information is obtained by performing linear filtering to the OFDM symbols.

15. The interpolating method according to claim 13, wherein the interpolation can be performed according to the following formula:
$$csi\_f \_int p ( m , n ) = {\sum }_{i = 1}^{fil\_len} csi\_t \_int p ( m , n - \frac{3}{2} \cdot fil\_len + 3 gi - 2 ) \cdot fil\_co ( i )$$

16. The interpolating method according to claim 13, wherein the interval between the inserted scattered pilots satisfies Nyquist sampling theorem.

17. The interpolating method according to claim 13, wherein the number of the virtual pilots is determined to be half length of the FIR filter.

18. A channel estimation method for an OFDM system, comprising:
estimating CSI of received scattered pilots in OFDM symbols by dividing the known transmitted scattered pilots;
obtaining the channel state information on the sub-channel which propagate the scattered pilots and storing the channel state information; and
inserting at least one copy of the first scattered pilot in each OFDM symbol before the first scattered pilot as virtual pilots and inserting at least one copy of the last scattered pilot in each OFDM symbol behind the last scattered pilot as virtual pilots, and performing channel estimation by interpolating with a FIR filter using the channel state information.

19. The channel estimation method according to claim 18, wherein the channel state information is obtained by performing linear filtering to the OFDM symbols.

20. The channel estimation method according to claim 18, wherein the interpolation can be performed according to the following formula:
$$csi\_f \_int p ( m , n ) = {\sum }_{i = 1}^{fil\_len} csi\_t \_int p ( m , n - \frac{3}{2} \cdot fil\_len + 3 gi - 2 ) \cdot fil\_co ( i )$$

21. The channel estimation method according to claim 18, wherein the interval between the inserted scattered pilots satisfies Nyquist sampling theorem.

22. The channel estimation method according to claims 18, wherein the number of the virtual pilots is determined to be half length of the FIR filter.

23. A channel estimation apparatus, comprising:
a pre-processor for performing channel estimation of the scattered pilots in OFDM symbols;
a time domain interpolation module, coupled to the pre-processor, for obtaining the channel state information on the sub-channels which propagate the scattered pilots; and
a frequency domain interpolation module, coupled to the time domain interpolation module, for inserting at least one copy of the first scattered pilot in each OFDM symbol before the first scattered pilot as virtual pilots, and inserting at least one copy of the last scattered pilot in each OFDM symbol behind the last scattered pilot as virtual pilots, and performing channel estimation by interpolating with a FIR filter using the channel state information.

24. The channel estimation apparatus according to claim 23, wherein the time domain interpolation module performs linear filtering to the OFDM symbols to obtain the channel state information.

25. The channel estimation apparatus according to claim 23, wherein the interpolation can be performed according to the following formula:
$$csi\_f \_int p ( m , n ) = {\sum }_{i = 1}^{fil\_len} csi\_t \_int p ( m , n - \frac{3}{2} \cdot fil\_len + 3 gi - 2 ) \cdot fil\_co ( i )$$

26. The channel estimation apparatus according to claim 23, wherein the interval between the inserted scattered pilots satisfies Nyquist sampling theorem.

27. The channel estimation apparatus according to claim 23, wherein the number of the virtual pilots is determined to be half length of the FIR filter.
